(19) United States
(12) Patent Application Publication
(10) Pub. No.: US 2009/0254882 A1
(43) Pub. Date: Oct. 8, 2009

(54) METHODS AND DEVICES FOR ITERATIVE BINARY CODING AND DECODING OF XML TYPE DOCUMENTS

(75) Inventor: HERVE RUELLAN, RENNES (FR)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/417,121

(22) Filed: Apr. 2, 2009

(30) Foreign Application Priority Data
Apr. 7, 2008 (FR) 0852319

(51) Int. Cl. G06F 17/00; G06F 9/44

(52) U.S. Cl. 717/120; 715/234

(57) ABSTRACT

The invention concerns iterative binary coding/decoding for a document comprising values to code or to decode. For the coding, after having created (400) a dictionary on the basis of the values to code, differences between consecutive elements of the dictionary created are calculated (440). These creating and calculating steps are repeated (460) by substituting the values to code by differences between the values of the dictionary created previously. The values of the document are then coded (480) on the basis of said created dictionaries. For the decoding, after having obtained (610, 640) a set of values representing differences between elements of a dictionary on the basis of coded values, elements of the dictionary are calculated (650) on the basis of said values obtained. These steps are repeated by substituting the values representing differences by the values of the dictionary calculated previously (630). The values are then decoded (670) on the basis of said calculated dictionaries.

The present invention concerns the optimization of files of XML type and more particularly methods and devices for iterative binary coding and decoding of XML type documents, in particular documents of SVG type.

### BACKGROUND OF THE INVENTION

XML (acronym for Extensible Markup Language) is a syntax for defining computer languages. XML makes it possible to create languages that are adapted for different uses but which may be processed by the same tools.

An XML document is composed of elements, each element starting with an opening tag comprising the name of the element, for example, <tag>, and ending with a closing tag which also comprises the name of the element, for example, </tag>. Each element can contain other elements or text data.

An element may be specified by attributes, each attribute being defined by a name and having a value. The attributes are placed in the opening tag of the element they specify, for example <tag attribute=“value”>.

XML syntax also makes it possible to define comments, for example “<!—Comment—>”, and processing instructions which may specify to a computer application what processing operations to apply to the XML document, for example “<?myprocessing?>”.

The elements, attributes, text data, comments and processing instructions are grouped together under the generic name of node.

Several different XML languages may contain elements of the same name. To use several different languages, an addition has been made to XML syntax making it possible to define namespaces. Two elements are identical only if they have the same name and are situated in the same namespace. A namespace is defined by a URI (acronym for Uniform Resource Identifier), for example http://canon.crf.fr/xml/mylanguage. The use of a namespace in an XML document is via the definition of a prefix which is a shortcut to the URI of that namespace. The prefix is defined using a specific attribute. By way of illustration, the expression xmlns:ml=“http://canon.crf.fr/xml/monlangage” associates the prefix “ml” with the URI http://canon.crf.fr/xml/monlangage. The namespace of an element or of an attribute is specified by having its name preceded by the prefix associated with the namespace followed by ‘:’, (for example ‘<ml:tag ml:attribute=“value”>’.

XML has numerous advantages and has become a standard for storing data in a file or for exchanging data. XML makes it possible in particular to have numerous tools for processing the files generated. Furthermore, an XML document may be manually edited with a simple text editor. Moreover, an XML document, containing its structure integrated with the data, is very readable even without knowing the specification.

However, the main drawback of the XML syntax is to be very prolix. Thus, the size of an XML document may be several times greater than the inherent size of the data. This large size of XML documents thus leads to a long processing time when XML documents are generated and especially when they are read.

To mitigate these drawbacks, mechanisms for coding XML documents have been sought. The object of these mechanisms is to code the content of the XML document in a more efficient form but enabling the XML document to be easily reconstructed. However, most of these mechanisms do not maintain all the advantages of the XML format. Numerous new formats, enabling the data contained in an XML document to be stored, have thus been proposed. These different formats are grouped together under the appellation “Binary XML”.

Among these mechanisms, the simplest consists of coding the structural data in a binary format instead of using a text format. Furthermore, the redundancy in the structural information in the XML format may be eliminated or at least reduced. Thus, for example, it is not necessarily useful to specify the name of the element in the opening tag and the closing tag. This type of mechanism is used by all the Binary XML formats.

Another mechanism consists of creating one or more index tables which are used, in particular, to replace the names of elements and attributes that are generally repeated in an XML document. Thus, at the first occurrence of an element name, it is coded normally in the file and an index is associated with it. Then, for the following occurrences of that element name, the index will be used instead of the complete string, reducing the size of the document generated, but also facilitating the reading. More particularly, there is no need to read the entire string in the file and, furthermore, determining the element read may be performed by a simple comparison of integers and not by a comparison of strings. This type of mechanism is implemented in several formats, in particular in the formats in accordance with the Fast Infoset and Efficient XML Interchange (EXI) recommendations.

This mechanism may be extended to the text values and to the values of the attributes. In the same way, at the first occurrence of a text value or an attribute value, this is normally coded in the file and an index is associated with it. The following occurrences of that value are coded using the index. This type of mechanism is implemented in several formats, in particular the formats in accordance with the Fast Infoset and EXI recommendations.

Still another mechanism consists of using index tables for describing the structure of certain categories of nodes of the document. Thus, for example, it is possible to use an index table for each element node having a given name. At the first occurrence of a child node in the content of that node, a new entry describing that child node type is added to the index table. At following occurrences of a similar node, that new child node is described using the associated index. This type of mechanism is implemented in the formats in accordance with the EXI recommendations.

The SVG data format (SVG being an acronym for Scalable Vector Graphics) is an XML language enabling vectorial graphics to be described. SVG uses the XML format and defines a set of elements and attributes making it possible in particular to describe geometric shapes, transformations, colors and animations.

A much used tool in SVG is the graphics path. A graphics path is a set of commands and associated coordinates, making it possible to describe a complex graphics form on the basis of segments, Bezier curves and circle arcs.

Binary XML formats may be used to code SVG documents. However, most of these formats have limitations with regard to the coding of SVG documents. This is because, in numerous SVG documents, the proportion of structure is small relative to the proportion of content. However, Binary XML formats are mainly directed to compressing the structure of XML documents. In relation to content, Binary XML formats can index the values, in order not to code several times the same value that is repeated in the content. They may also code, in a specific way, certain contents of which the type is known and simple, for example an integer or a real number. But SVG contents satisfy none of these criteria: SVG contents which are large in size are rarely repeated and generally do not correspond to simple types. These contents of large size are for example graphics paths, which mix simple graphics commands with coordinates or lists of integer or real values.

For this reason, it is necessary to create new Binary XML formats that are specific to SVG documents or to adapt existing Binary XML formats to efficiently code SVG documents.

The patent U.S. Pat. No. 6,624,769 describes a Binary XML format adapted to code SVG documents. This patent describes in particular a specific way to code SVG paths consisting of coding the commands used in the path and only attributing a code to the commands present in the path. Furthermore, these codes are Huffman type codes, of which the attribution is predefined for all the existing commands.

The command arguments are coded in binary manner, using a minimum number of bits enabling any argument present in the path to be coded. More precisely, the patent is limited to the coding of integer arguments, corresponding to the SVG profiles for mobile telephones, and separates the arguments into two categories: the arguments corresponding to absolute commands and those corresponding to relative commands. In the case of an absolute command, the argument directly represents a position in the SVG reference frame whereas in the case of a relative command, the argument represents the movement from the previous position. For each type of argument, calculation is made of the minimum number of bits enabling any argument of that type present in the path to be coded. Next, each argument is coded over a number of bits depending on its type.

The format described in this patent enables compact SVG documents to be obtained, but only applies to a restricted category of documents and is still of limited efficacy in the case of large paths.

Furthermore, a type of coding which may be used to code a series of numbers is coding by dictionary wherein the set of values taken by the different numbers is first coded. This set of values constitutes a dictionary which is used to code the numbers. Thus, for each number, the index of that number in the dictionary is coded.

Such a type of coding is generally efficient for SVG values.

Another type of coding which may be used to code a series of numbers is coding by delta, in which each number is coded not directly, but relative to the preceding one. Thus, for each number, the difference between that number and the preceding one is coded. This system is efficient in the case of series of number of which the variation is small relative the value of the number.

In the case of SVG, this type of coding is partially integrated into the language by the existence of the relative commands. Moreover, the variations between two successive numbers are often of the same order of magnitude as the numbers themselves. Lastly, in the case of paths, two successive numbers represent values corresponding to two different coordinates, which are thus relatively independent.

### SUMMARY OF THE INVENTION

The invention notably makes it possible to increase the efficiency of compressing series of data, in particular series of numbers, notably data of SVG type.

The invention thus relates to a coding method for coding a structured document comprising at least one plurality of values to code, the method comprising the following steps,

creating a first dictionary on the basis of said values to code;

calculating the differences between at least two consecutive elements of said created first dictionary;

creating a second dictionary on the basis of the calculated differences; and,

coding said plurality of values of said document on the basis of said created first dictionary and second dictionary.

The method according to the invention thus makes it possible to improve the coding of structured documents, for example of XML type, in particular documents of XML type comprising a series of numbers, to optimize the size of the coded document.

According to a particular embodiment, said created first dictionary comprises each value of said values to code, without repetition.

Still according to a particular embodiment, the method further comprises a step of sorting the elements of at least one created dictionary, prior to said step of calculating the differences, in order to improve the coding.

Still according to a particular embodiment, the method further comprises a step of indexing the elements of at least one created dictionary, prior to the step of coding said plurality of values, the coding of at least one value to code comprising a step of substituting said at least one value to code by an index. The use of indices substituting for values enables the coding to be optimized.

Advantageously, the method further comprises a step of calculating differences between at least two consecutive elements of said created second dictionary and a step of creating a third dictionary on the basis of said differences calculated on the basis of said created second dictionary, said plurality of values of said document being coded on the basis of said created first dictionary, second dictionary, and third dictionary.

According to a particular embodiment, the method further comprises a step of normalizing at least one value of said plurality of values. In particular, if at least some of the values of said plurality of values represent coordinates, said normalizing step may comprise a step of converting absolute coordinates into relative coordinates or of converting relative coordinates into absolute coordinates. Thus, according to the nature of the values to code, it is possible to reduce the size of the values to code, and thus to improve the coding.

Similarly, if at least some of the values of said plurality of values represent coordinates, each component of said plurality of values forming a plurality of values is preferably coded independently in order to take into account the relation that may exist between the values to code to optimize the coding.

Still according to a particular embodiment, the method further comprises a step of comparing at least two said differences calculated between at least three elements of a created dictionary with at least one predetermined threshold, said at least two said differences being considered as distinct if their difference is greater than said predetermined threshold. Thus, if a difference between two elements of a dictionary is considered as negligible, the two elements may be grouped together into a single element to improve the coding.

Said document may in particular be a document of XML type or SVG type.

If said plurality of values to code belongs to a path of SVG type, said method further comprises, advantageously, a step of separating between said plurality of values and at least one command to optimize the coding by taking into account the link that may exist between the values to code.

The invention also relates to a method for decoding a structured document comprising a plurality of coded values, the structured document being coded according to the coding method described above, this decoding method comprising the following steps,

obtaining a set of values representing differences between a plurality of elements of a first dictionary based on said plurality of coded values;

calculating the elements of said first dictionary on the basis of said values obtained;

calculating elements of a second dictionary on the basis of said elements of said first dictionary and of said plurality of coded values; and,

decoding at least one value of said plurality of coded values on the basis of said first dictionary and second dictionary.

The method according to the invention thus makes it possible to decode documents coded using an optimized coding.

Advantageously, the method further comprises a step of calculating elements of a third dictionary on the basis of said elements of said second dictionary and of said plurality of coded values, said at least one decoded value being decoded on the basis of said first dictionary, said second dictionary, and said third dictionary.

According to a particular embodiment, the method further comprises a step of index decoding, said step of decoding at least one value of said plurality of coded values comprising a step of substituting a decoded index by a value of one of said dictionaries in order to take into account the optimization steps of the coding.

The invention also relates to a computer program comprising instructions adapted for the implementation of each of the steps of the method described earlier, as well as information storage means, removable or not, that are partially or totally readable by a computer or a microprocessor containing code instructions of a computer program for executing each of the steps of the method described earlier.

The invention also relates to a coding device for coding a structured document comprising at least one plurality of values to code, the device comprising the following means,

means for creating a first dictionary on the basis of said values to code;

means for calculating the differences between at least two consecutive elements of said created first dictionary;

means for creating a second dictionary on the basis of the calculated differences; and

means for coding said plurality of values of said document on the basis of said created first dictionary and second dictionary.

The device according to the invention thus makes it possible to improve the coding of structured documents, for example of XML type, in particular documents of XML type comprising a series of numbers, to optimize the size of the coded document.

According to a particular embodiment, the device further comprises means for sorting elements of at least one created dictionary, prior to said calculation of the differences, in order to improve the coding.

Still according to a particular embodiment, the device further comprises means for indexing elements of at least one created dictionary, prior to said coding of said plurality of values, said means for coding said plurality of values comprising means for substituting at least one of said values to code by an index. The use of indices substituting for values enables the coding to be optimized.

Still according to a particular embodiment, the device further comprises means for calculating differences between at least two consecutive elements of said created second dictionary and means for creating a third dictionary on the basis of said differences calculated on the basis of said created second dictionary, said plurality of values of said document being coded on the basis of said created first dictionary, second dictionary, and third dictionary

Still according to a particular embodiment, the device further comprises means for normalizing at least one value of said plurality of values. In particular, if at least some of the values of said plurality of values represent coordinates, said normalizing means may comprise means for converting absolute coordinates into relative coordinates or for converting relative coordinates into absolute coordinates. Thus, according to the nature of the values to code, it is possible to reduce the size of the values to code, and thus to improve the coding.

Still according to a particular embodiment, the device further comprises means for comparing at least two said differences calculated between at least three elements of a created dictionary with at least one predetermined threshold, said at least two said differences being considered as distinct if their difference is greater than said predetermined threshold. Thus, if a difference between two elements of a dictionary is considered as negligible, the two elements may be grouped together into a single element to improve the coding.

If said plurality of values to code belongs to a path of SVG type, said device further comprises, preferably, means for separating said plurality of values from at least one command to optimize the coding by taking into account the link that may exist between the values to code.

The invention also relates to a decoding device for a structured document comprising a plurality of coded values, this device comprising the following means,

means for obtaining a set of values representing differences between a plurality of elements of a first dictionary based on said plurality of coded values;

means for calculating elements of said first dictionary on the basis of said values obtained;

means for calculating elements of a second dictionary on the basis of said elements of said first dictionary and of said plurality of coded values; and

means for decoding at least one value of said plurality of coded values on the basis of said first dictionary and second dictionary.

The device according to the invention thus makes it possible to decode documents coded using an optimized coding.

According to a particular embodiment, the device further comprises means for decoding indices, said means for decoding at least one value of said plurality of coded values comprising means for substituting a decoded index by a value of one of said dictionaries in order to take into account the optimization steps of the coding.

### BRIEF DESCRIPTION OF THE DRAWINGS

Other advantages, objects and features of the present invention will emerge from the following detailed description, given by way of non-limiting example, relative to the accompanying drawings in which:

FIG. 1 shows an example of a device making it possible to implement the invention at least partially;

FIG. 2 illustrates a geometrical object defined by an XML file of SVG type;

FIG. 3 represents an example of an algorithm for coding an SVG path according to the invention;

FIG. 4 represents an example of an algorithm for coding a list of numerical values using a differential dictionary;

FIG. 5 illustrates an example of a decoding algorithm making it possible to decode an SVG path coded using the algorithm described with reference to FIG. 3; and,

FIG. 6 represents an example of an algorithm for decoding a value list by differential dictionary.

### DETAILED DESCRIPTION OF THE INVENTION

The invention consists in particular of a method of coding for SVG paths, enabling a compact representation of the values used in those documents. This method of coding consists, in particular, of coding the arguments of the commands of an SVG path using a dictionary that is itself coded.

The values of the dictionary are sorted then the differences between the consecutive values are calculated. The values obtained are then coded themselves using a second dictionary. The coding of the values of this second dictionary is also performed by sorting its values, then by calculating the differences between the consecutive values. These differences are then directly coded.

The coding method used by the invention is recursive: the coding by dictionary is applied several times to the set of values to code, the first set being the parameters of an SVG path and the second being the values of the dictionary. This recursive application of the coding by dictionary makes it possible to obtain a high compression rate for SVG paths.

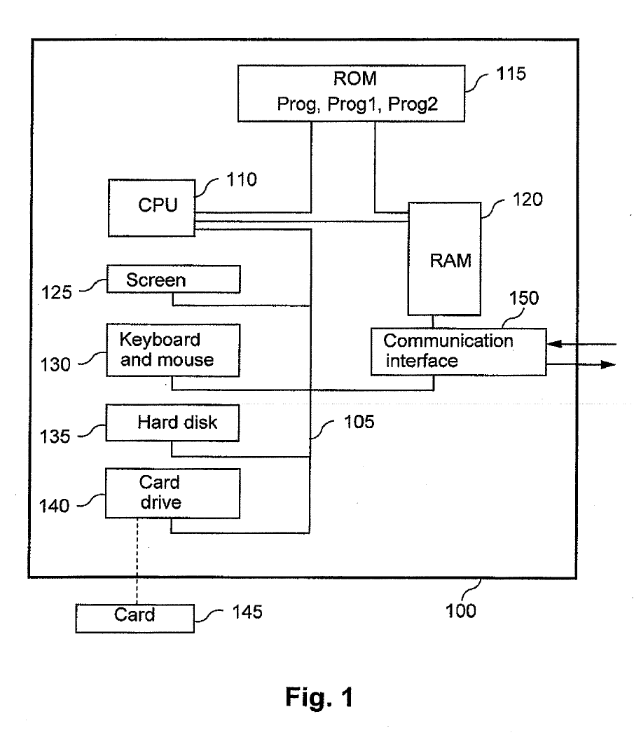

An device adapted to implement the invention or a part of the invention is illustrated in FIG. 1. The device 100 is for example a workstation, a micro-computer, a personal assistant or a mobile telephone.

The device 100 here comprises a communication bus 105 to which there are connected:

a central processing unit (CPU) or microprocessor 110;

a read-only memory (ROM) 115 able to contain the programs “Prog”, “Prog1” and “Prog2”;

a random access memory (RAM) or cache memory 120, comprising registers adapted to record variables and parameters created and modified during the execution of the aforementioned programs; and,

a communication interface 150 adapted to transmit and to receive data.

Optionally, the device 100 may also have:

a screen 125 making it possible to view data and/or serving as a graphical interface with the user who will be able to interact with the programs according to the invention, using a keyboard and a mouse 130 or another pointing device, a touch screen or a remote control;

a hard disk 135 able to contain the aforementioned programs “Prog”, “Prog1” and “Prog2” and data processed or to be processed according to the invention; and,

a memory card reader 140 adapted to receive a memory card 145 and to read or write thereon data processed or to be processed according to the invention.

The communication bus allows communication and interoperability between the different elements included in the device 100 or connected to it. The representation of the bus is non-limiting and, in particular, the central processing unit may communicate instructions to any element of the device 100 directly or by means of another element of the device 100.

The executable code of each program enabling the programmable device to implement the methods according to the invention may be stored, for example, on the hard disk 135 or in read only memory 115.

According to a variant, the memory card 145 can contain data as well as the executable code of the aforementioned programs which, once read by the device 100, is stored on the hard disk 135.

According to another variant, it will be possible for the executable code of the programs to be received, at least partially, via the interface 150, in order to be stored in identical manner to that described previously.

More generally, the program or programs may be loaded into one of the storage means of the device 100 before being executed.

The central processing unit 110 will control and direct the execution of the instructions or portions of software code of the program or programs according to the invention, these instructions being stored on the hard disk 135 or in the read-only memory 115 or in the other aforementioned storage elements. On powering up, the program or programs which are stored in a non-volatile memory, for example the hard disk 135 or the read only memory 115, are transferred into the random-access memory 120, which then contains the executable code of the program or programs according to the invention, as well as registers for storing the variables and parameters necessary for implementation of the invention.

It should be noted that the communication apparatus comprising the device according to the invention can also be a programmed apparatus. This apparatus then contains the code of the computer program or programs for example fixed in an application specific integrated circuit (ASIC).

The following example illustrates an example of SVG document content able to be processed by the method according to the invention,

```
<?xml version=“1.0” encoding=“UTF-8”?>
<!DOCTYPE svg PUBLIC “-//W3C//DTD SVG 1.1//EN”
    “http://www.w3.org/Graphics/SVG/1.1/DTD/svg11-basic.dtd”>
<svg xmlns=http://www.w3.org/2000/svg
    viewBox=“0 0 200 200” width=“200” height=“200”>
    <path stroke=“black” fill=“white” stroke-width=“1”
        d=“M100.00 180.00 L76.91 140.00 30.72 140.00 53.81 100.00
            30.72 60.00 76.91 60.00 100.00 20.00 123.09 60.00
            169.28 60.00 146.19 100.00 169.28 140.00
            123.09 140.00Z”/>
</svg>
```

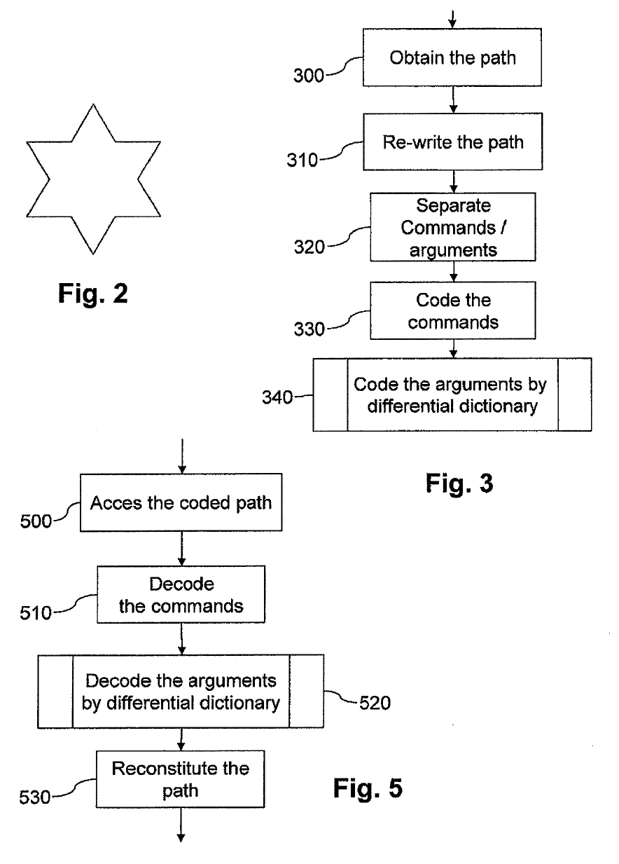

This SVG document contains, in addition to the SVG header, a single path described in the “path” tag. It represents a Koch snowflake, in the first iteration. A graphical view of this SVG document is illustrated in FIG. 2.

In this document, the upper case letters M, L and Z represent commands of the SVG path. M corresponds to the command “moveto”, that is to say go to the point of which the coordinates follow. L corresponds to the command “lineto”, that is to say connect the preceding point to the point of which the coordinates follow. Z corresponds to the command “closepath”, that is to say connect the preceding point to preceding point to the first point of the path.

The commands M and L each take two arguments, corresponding to the coordinates of the point. However, when a command is repeated, it is not necessary to state it again. It is for this reason that the letter L only appears once in the path, whereas the path is constituted by several “lineto” commands.

The commands M, L and Z correspond to commands of which the coordinates are given in absolute manner relative to the reference frame used. There is another version of these commands, represented by the lower case letters m, l and z, which have as parameter relative coordinates, expressed relative to the coordinates of the preceding point.

FIG. 3 represents an example of an algorithm for coding an SVG path according to the invention.

A first step (step 300) makes it possible to obtain the path to code. By way of illustration, it is considered here that the path to code is that indicated earlier, that is to say the following path,

M100.00 180.00 L76.91 140.00 30.72 140.00 53.81 100.00 30.72 60.00 76.91 60.00 100.00 20.00 123.09 60.00 169.28 60.00 146.19 100.00 169.28 140.00 123.09 140.00Z

In a following step (step 310), the path is re-written. The object of this re-writing is to use only relative commands within the path. Nevertheless, since there is no reference for the arguments of the first command, this remains an absolute command. However, it may be re-written as a relative command since the SVG recommendations specify that if a path begins with a relative path, this must be processed as an absolute command.

The value of this transformation is to make all the arguments used in the path homogenous. Furthermore, in numerous situations, the choice of relative coordinates makes it possible to reduce the values (the absolute coordinates may have high values if the path is far from the origin whereas the relative coordinates have small values if the points forming the path stay close). Lastly, the number of commands that can be used is reduced by half, which makes it possible to use more compact coding for the commands.

Resuming the previous example, the re-written path may be written in the following form,

m100. 180. l−23.09 −40. −46.19 0. 23.09 −40. −23.09 −40. 46.19 0. 23.09 −40. 23.09 40. 46.19 0. −23.09 40. 23.09 40. −46.19 0.z

According to a first embodiment, this re-writing may be optimized to reduce the complexity of the coding by deleting a calculating step. Furthermore, in certain situations, it is possible to control the source of the SVG documents to generate paths using solely relative commands. In this case, it is needless to re-write the paths.

According to a second embodiment, the re-writing may transform all the relative commands into absolute commands. This is because, in certain situations, it is more efficient to use only absolute commands.

The choice of the re-writing to use may either be predetermined, or be determined for each path depending on the characteristics of the path or on the size obtained for the coding of the path depending on the choice made.

A following step (step 320) makes it possible to separate the commands from their arguments to code them separately, the commands being coded before the arguments.

Resuming the previous example, the extracted commands are the following,

m, l, l, l, l, l, l, l, l, l, l, l, z

This list of commands may also be written in the following form in which the consecutive identical commands are referenced only once with the number of occurrences,

m, l*11, z

According to the example given, the list of the arguments is the following,

100., 180., −23.09, −40., −46.19, 0., 23.09, −40., −23.09, −40., 46.19, 0., 23.09, −40., 23.09, 40., 46.19, 0., −23.09, 40., 23.09, 40., −46.19, 0.

The commands are then coded (step 330).

The coding used consists here of attributing a code over 4 bits to each command. The remaining coding values (here 6 values since the SVG recommendations define 10 relative commands) are used to code repetitions. This the list of the commands of the preceding example may be coded by the following sequence of bytes,

05 02 FD 10

in which the first byte “05” corresponds to the number of codes used and the following three bytes “02 FD 10” correspond to the commands contained in the path. The code “0” (coded over 4 bits or half a byte) corresponds to the command “m”, the code “2” to the command “l”, the code “F” to 6 repetitions of the previous command (that is to say here to the command “l”), the code “D” to 4 repetitions of the previous command (that is to say still to the command “l”) and the code “1” to the command “z”. The last code is completed by 4 bits at zero to terminate the byte.

Other types of coding may be used. In particular, the code used for each command may be of variable length. It is thus possible to use a Huffman type coding to code the different commands. However, this implies transmitting the description of the coding used. Another solution consists of determining a coding of Huffman type in advance, for the commands, which will be used for all the SVG paths (it should be noted that the commands “l” and “c” are those which are the most often used in paths).

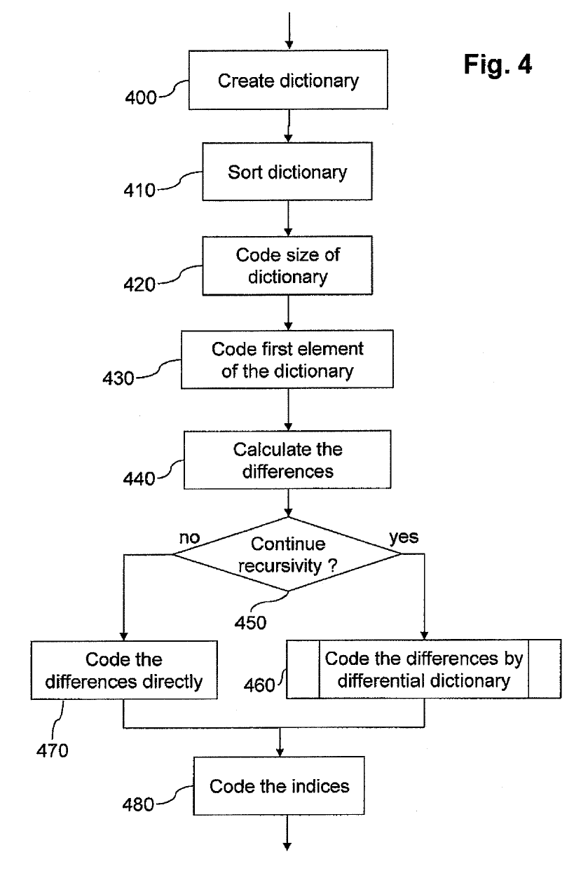

The purpose of a following step (step 340) is to code the arguments of the path commands. This step is carried out using a coding algorithm by differential dictionary of which an example is described with reference to FIG. 4.

The particular form of the representation of step 340 indicates the iterative character of this step. The same representation is used for the steps 460, 520 and 630.

It must be noted that the description of this algorithm only takes into account the numerical arguments of the SVG path commands. However, a few SVG path commands have arguments of Boolean type. These arguments are advantageously separated from the other arguments at the step of separating the commands and the arguments (step 320) and are coded after the list of the commands, one bit being used to code each Boolean argument.

Alternatively, these Boolean arguments may also be coded after the other arguments.

In another alternative, these Boolean arguments may be coded with the indices corresponding to the other arguments to maintain the order of the arguments.

Other types of arguments, for example strings, may be coded in similar manner.

FIG. 4 represents an example of an algorithm for coding a list of numerical values using a differential dictionary. This algorithm is preferentially applied to the arguments of XPath paths but it may also be applied to the lists of values contained in other SVG attributes, for example the Values or KeyTimes attributes, or for any other type of value of which the content is a number list.

The purpose of a first step (step 400) is to create a first dictionary, this first dictionary being used subsequently for coding the list of values. The first dictionary contains each of the values contained in the list, without repetition.

Thus, resuming the previous example, the first dictionary is constituted by the following elements,

100., 180., −23.09, −40., −46.19, 0., 23.09, 40, 46.19

The elements of the first dictionary are then sorted (step 410), for example in increasing order. The first dictionary so sorted is stored to serve as reference for coding by index of the list of values.

Determination of the indices associated with each of the sorted elements of the first dictionary may be performed here or later.

The steps 400 and 410 may be carried out simultaneously.

In the example considered, the first sorted dictionary is constituted by the following elements,

−46.19, −40., −23.09, 0., 23.09, 40., 46.19, 100., 180.

The coding of the size of the first dictionary is then carried out (step 420). This coding is carried out by directly coding the integer representing the number of elements present in the first dictionary.

In the example considered, the first dictionary comprises nine elements, the coded size is thus 09.

The first element of the first dictionary is then coded (step 430). According to a particular embodiment, the numerical values are coded in a particular format. A first byte is used to code a header which contains a first bit indicating whether the number is positive or not, then 4 bits indicating the number of decimals used and lastly 3 bits indicating the number of bytes used to code the number (the integer part and the decimal part of the number). Next, a variable number of bytes is used to code the number (the integer part and the decimal part are coded in the form of a single integer value). According to this coding, a number is coded over at least 2 bytes.

According to the example considered, the first element of the first dictionary is −46.19. This element may be coded in the following manner,

92 12 0B

in which the first byte, used as header, is 92, that is to say 10010010 in binary. The first bit, of which the value is equal to 1, indicates that the number is negative. The following four bits (0010), forming the value 2, indicating that the number has two decimals. The last three bits (010), forming the value 2, indicate that the integer number representing the integer part and the decimal part is coded over two bytes.

The second and third bytes (12 0B) form the value 4619 which corresponds to the integer number used to code the integer part and the decimal part.

It is to be noted that any other type of coding of the numerical value may be used.

A following step (step 440) consists of calculating the differences between the successive elements of the first dictionary. These differences form a first differences table that is associated with the first dictionary.

By way of illustration, the differences between the successive elements of the first dictionary according to the previous example are the following,

6.19, 16.91, 23.09, 23.09, 16.91, 6.19, 53.81, 80.

A test is then carried out to determine how this differences table is to be coded (step 450). This test consists for example of checking if the coding of the values of this table should be carried out recursively. Thus, step 450 may invoke the algorithm again to code a list of values obtained during the execution of that algorithm.

It should be noted here that the use of recursion in a compression algorithm does not generally make it possible to improve the compression rate. In numerous situations, the recursive application of a compression algorithm even leads to the opposite effect tending to reduce the compression rate. However, in the case of SVG paths and certain other values contained in SVG documents, the structure of the data is particular and the use of recursion proves to be efficient.

According to a preferred embodiment of the invention, step 450 consists of decrementing a recursion counter, initialized to a predetermined positive value, then of comparing the value obtained to zero. If that recursion counter reaches the value zero the algorithm continues at the step 470 in which the differences table is directly coded. On the contrary, if the recursion counter is greater than zero, the algorithm continues at the step 460 in which the differences table is coded by differential dictionary using that same algorithm.

Still according to a preferred embodiment, the recursion counter takes the value two as initial value. Consequently, the list of the arguments of the SVG path as well as the first differences table are coded using the algorithm described with reference to FIG. 4.

If a dictionary only comprises a single element, the corresponding differences table is empty and does not need to be coded.

Alternatively, the choice of the method of coding the differences table may be made on the basis of the size of the differences table. If the size of that table is less than a predetermined value, the algorithm continues at the step 470, otherwise the algorithm continues at the step 460.

In another variant embodiment, both forms of coding are tested for the table and that giving the most compact result is selected.

Still according to another variant embodiment, several of the preceding variant embodiments are combined.

It is to be noted that if the embodiment of step 450 is not deterministic, the result of the test 450 must be coded such that, on decoding, the right decoding method is used.

According to the example illustrated and considering the preferred embodiment of the invention, the recursion counter is decremented and takes the value 1. The algorithm therefore continues at step 460.

At step 460, in case of a positive result for the test 450, the differences table is coded using that same algorithm recursively.

Thus, in this example, for the first differences table, a second dictionary, termed differential dictionary, is created and sorted, and then contains the following elements,

6.19, 16.91, 23.09, 53.81, 80.

Next, the size of this second dictionary, equal to 5, is coded (05).

The first element of this second dictionary is then coded according to the scheme described previously,

12 02 6B

in which 12 (that is to say 00010010 in binary) indicates that the number is positive (first bit at 1), that it includes two decimals (four following bits at 0010) and that two bytes are used to code the number (three following bits at 010).

The second and third bytes (02 6B) form the value 619 which corresponds to the integer number used to code the integer part and the decimal part of the number.

The differences table of this second dictionary, termed second differences table, is then calculated to obtain the following values,

10.72, 6.18, 30.72, 26.19

For the coding of the second differences table, the recursion counter is decremented and takes the value 0. The result of the test 450 is thus negative and the algorithm continues at the step 470.

At step 470, in case of a negative result for the test 450, the second differences table is coded without recursive invocation of that algorithm.

According to the preferred embodiment of the invention, a coding table is created containing each of the values present a single time in the second differences table. This coding table is then sorted and all the values contained therein is directly coded. The values contained in the second differences table are then replaced by the indices determined relative to that coding table.

Thus, in the described example, the preceding second differences table is coded according to this embodiment. The sorted coding table contains the following elements,

6.18, 10.72, 26.19, 30.72

These values are directly coded, using the same format as previously (whereby the first byte corresponds to the coding format of the values), preceded by their number, in the following manner,

04 12 02 6A 12 04 30 12 0A 3B 12 0C 00

in which 04 corresponds to the number of elements of the table, the first indication 12 specifies the coding format of the first value, 026A corresponds to the value of the first element, the second indication 12 specifies the coding format of the second value, 0430 corresponds to the value of the second element and so forth for all the elements of the coding table.

An index is associated with each element of the coding table, in increasing order. Thus, the index 0 is associated with the value 6.18, the index 1 with 10.72, the index 2 with 26.19 and the index 3 with 30.72.

Next, the values of the second differences table are coded. For this, each value is replaced by the index determined using the coding table. The list of the indices of the elements of the second differences table is thus, for the second dictionary, the following:

1, 0, 3, 2

As the number of index values to code is four, each index is preferably coded over 2 bits. The list of the indices is thus coded by the value 4E.

In a variant, at step 470, the differences table is directly coded. For this, each element of the table is coded as a number.

In all cases, after step 460 or after step 470, the algorithm continues at the step 480 which consists of coding the elements of the first differences table using the indices corresponding to each of the values, that are sorted, of the second dictionary. Each index is coded over a minimum number of bits to code the number of elements contained in the sorted dictionary.

Thus, the index 0 is associated with the value 6.19, the index 1 with 16.91, the index 2 with 23.09 the index 3 with 53.81 and the index 4 with 80

According to the described example, the list of the indices to code for the first differences table, according the indices determined from the sorted elements of the second dictionary is the following,

0, 1, 2, 2, 1, 0, 3, 4

As five values are possible, these indices are each coded over 3 bits. The concatenation of the binary representations of the values 0, 1, 2, 2, 1, 0, 3 and 4 is equal to 000001010010001000011100 i.e. the following value,

05 22 1C

The recursive invocation of the algorithm of FIG. 4 is then terminated. The processing thus continues at step 480 for the coding of the indices corresponding to the arguments list.

Indices are associated with the sorted elements of the first dictionary. As indicated previously, this association may be made during the coding of the indices or at the time of the determination of the elements of the first dictionary. According to the described example, the index 0 corresponds to the value −46.19, the index 1 to −40, the index 2 to −23.09, the index 3 to 0, the index 4 to 23.09, the index 5 to 40, the index 6 to 46.19, the index 7 to 100 and the index 8 to 180.

Each argument of the path commands is then replaced by the corresponding index determined on the basis of the indices associated with the sorted elements of the first dictionary. The list of the arguments of the path commands is then the following,

7, 8, 2, 1, 0, 3, 4, 1, 2, 1, 6, 3, 4, 1, 4, 5, 6, 3, 2, 5, 4, 5, 0, 3

As nine index values are possible, these indices are each coded over four bits. The preceding index list may then be written in the following form,

78 21 03 41 21 63 41 45 63 25 45 03

It is to be noted that the consequence of the coding order used by the algorithm is that the different index lists follow each other. This makes it possible to use unused bits at the end of the code of an index list to begin the coding of the following index list.

The algorithm terminates after step 480.

The coding of the SVG path is then obtained by the concatenation of the coding of the commands and of the coding of the arguments, the coding of the arguments itself corresponding to the concatenation of the coding of the number of elements of the first dictionary, of the coding of the first element of the first dictionary, of the coding of the size of the second dictionary, of the coding of the first element of the second dictionary, of the coding of the values of the second dictionary, of the coding of the list of the indices associated with the second dictionary, of the coding of the list of the indices associated with the first dictionary and of the coding of the list of the indices of the arguments of the path commands.

As stated previously, it is possible to use more than two dictionaries. Nevertheless, the coding scheme of an SVG path remains similar, according to an encapsulation mechanism linked to the iterative character of the algorithm.

In the described example, the path contained in the SVG document is constituted by 162 characters. A standard representation of this path will thus require 162 bytes.

This same path is coded by the method according to the invention with the following list of bytes,

05 02 FD 10 09 92 12 0B 05 12 02 6B 04 12 02 6A 12 04 30 12 0A 3B 12 0C 00 4E 05 22 1C 78 21 03 41 21 63 41 45 63 25 45 03

constituted by 41 bytes.

In comparison, a simplification in the writing of the initial path, by removing the zero decimals, makes it possible to reduce the size of the path to 119 bytes. The application to this simplified path of conventional compression techniques enables its size to be reduced to approximately 100 bytes.

Still in comparison, an adaptation of the algorithm proposed in the patent U.S. Pat. No. 6,624,769 necessitates a minimum of 45 bytes to which the size of the coding of the commands must be added, and the size of the coding of the headers.

In a variant, the indices are not coded directly but using a Huffman type code. For this, a code is attributed to each index value, of which the size depends on its frequency of use (the shortest codes being attributed to the most frequent values). Next, on coding the indices, each index is replaced by its associated code. However, it is necessary to transmit information enabling the decoder to reconstitute the codes associated with each index. For this, the list of the indices in order of frequency is coded, preferably prior to the coding of the values list.

In another variant, in order to reduce the size of the additional information requiring to be transmitted, index values among the most frequent are selected, the number of these values being predetermined. These selected index values have short codes attributed to them, whereas the non-selected index values have long codes attributed to them of identical size. Thus, the additional information to transmit is reduced to the selected index values. Preferably, the predetermined number depends on the number of index values. Preferably, the short codes have different lengths, the shortest codes being associated with the most frequent values.

FIG. 5 illustrates an example of a decoding algorithm making it possible to decode an SVG path coded using the algorithm described with reference to FIG. 3.

After having obtained the SVG path, in its coded form, during a first step (step 500), the list of the commands composing the SVG path is decoded (step 510). Each of the commands is here decoded after having decoded the number of commands.

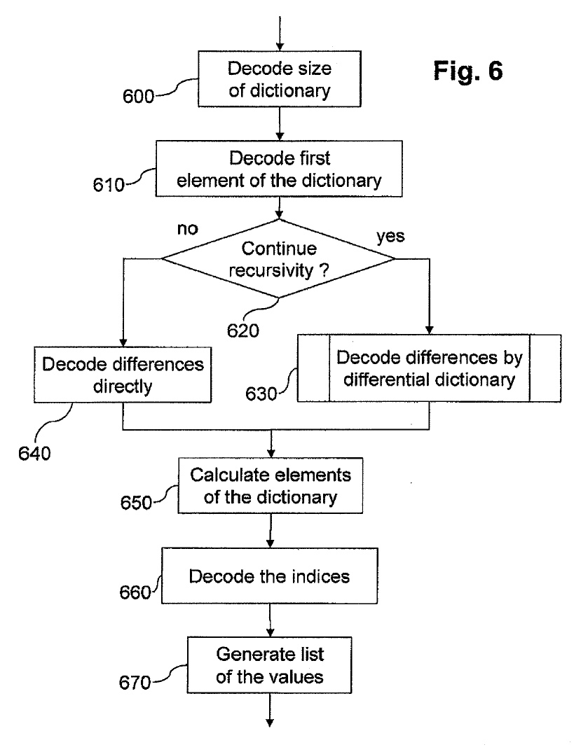

The arguments corresponding to this list of commands are then decoded (step 520) using the differential decoding described with reference to FIG. 6. The number of arguments to decode is calculated on the basis of the list of the decoded commands.

The SVG path is then reconstituted (step 530). For this, the algorithm successively writes each of the decoded commands with its respective arguments.

It should be noted that if a step of re-writing the SVG path has been carried out during the coding, the opposite step is not carried out on decoding. Consequently, the decoded SVG document is not identical, in terms of syntax, to the coded SVG document. However, as the re-writing does not modify the semantics of the document, that is to say the graphics described by the SVG document, the decoded SVG document enables the same graphics to be generated as the initial SVG document.

Again, as was the case with regard to FIG. 3, the decoding of the Boolean arguments is not described here but is immediately deduced from the description of the coding used.

FIG. 6 represents an example of an algorithm for decoding a value list by differential dictionary. This algorithm uses the number of values to decode as a parameter.

A first step (step 600) is to decode the number of elements contained in the first dictionary, that is to say the size of the first dictionary.

The first element of the first dictionary is then decoded (step 610).

A test is then carried out to determine whether the decoding algorithm must continue recursively or not (step 620). This test corresponds to the test carried out at step 450 of FIG. 4. It is carried out in similar manner. If the test result is positive, the algorithm continues at the step 630 otherwise is continues at step 640.

At step 630, the differences between the successive elements of the dictionary are decoded by recursively invoking that algorithm for decoding by differential dictionary. The number of values to decode is that decoded at step 600.

At step 640, the differences between the successive elements of the dictionary are decoded directly, depending on the coding carried out at step 470 of FIG. 4.

In all cases, the algorithm continues at step 650. At this step, the elements of the dictionary are calculated. The different elements are calculated one by one, starting with the first element decoded at step 610, using the differences decoded at one of the steps 630 and 640.

The indices of the values are next decoded (step 660). The number of indices to decode is that used as parameter of the algorithm. The number of bits used for each index preferably depends on the number of elements in the dictionary. This number of bits is the minimum number of bits to code the number of elements contained in the dictionary. Other types of coding may be used, in relation with the coding phase.

The list of the values is next reconstructed (step 670): each index decoded at the preceding step is replaced by its associated value contained in the dictionary.

Even though the method according to the invention has been described for the SVG path, it may be used to code any list of numerical values forming part of a text content of an XML document. It may be a text node or the value of an attribute. In particular, the invention may apply to other SVG attributes as the “values” attribute which defines a list of values or the “keyTimes” attribute which defines a list of times.

According to this embodiment, the coding algorithm described with reference to FIG. 3 is simplified. Step 300 is replaced by a step of obtaining the list of values to code. Steps 310, 320 and 330 are replaced by a single step of coding the number of values contained in the list.

Similarly, the decoding algorithm described with reference to FIG. 5 is simplified. Step 510 is replaced by a step of decoding the number of values contained in the list. Step 530 is eliminated as no additional processing is necessary to reconstitute the list of the values yielded by step 520.

The method according to the invention may also be applied to other languages for description of graphics in two dimensions in XML, such as Microsoft Silverlight (Silverlight is a trademark) or Adobe Mars, or using other syntaxes, such as Adobe Postscript (Postscript is a trademark), Adobe PDF (PDF is a trademark), or Autodesk DXF (DXF is a trademark). It may also be applied to graphical interface description languages, such as XAML (acronym for eXtensible Application Markup Language), XUL (acronym for XML-based User interface Language), UIML (acronym for User Interface Markup Language), Adobe Flex (Flex is a trademark) and OpenLaszlo. It may furthermore be applied to languages enabling multimedia descriptions, in particular to code lists of temporal values. These languages include SMIL (acronym for Synchronized Multimedia Integration Language). Lastly, it may be applied to languages for graphical description in three dimensions, in particular to code lists of points in three dimensions. These languages include for example X3D (acronym for Extensible 3D).

Another variant embodiment consists of separately coding the different numerical values depending on their category. Thus, in the case of paths, the arguments corresponding to x-coordinates will be coded separately from the arguments corresponding to y-coordinates. For this, at a step 320, the arguments are separated into different categories. Next, at the step 340, the algorithm for coding by differential dictionary is used for the list of the arguments in each category. On decoding, the different lists of arguments are decoded separately, then all the arguments are reconstructed on the basis of those lists.

It is also possible to perform lossy coding. More particularly, in certain situations, approximations may lead to the obtainment of very similar values in the differences table. It is then preferable to merge these values into a single value to reduce the coding cost.

To that end, the coding algorithm described with reference to FIG. 4 may take as a parameter a value linked to a maximum error level. At step 410, during the sorting of the dictionary, if two elements of the dictionary have a difference less than that maximum error level, those two elements are merged.

Next, at the step 460 or the step 470 (in the case of coding using a dictionary), that maximum error level is transmitted. But as the steps 460 and 470 concern the differences table, an approximation on one of those differences may be cumulated at the time of the reconstitution of the elements of the dictionary. Thus, the maximum error level transmitted is not the initial maximum error level, but that maximum error level divided by the number of elements contained in the dictionary.

Lastly, at the step 470, if coding using a dictionary is used, the maximum error level is taken into account to reduce the number of elements contained in the dictionary by merging the close elements.

Naturally, to satisfy specific needs, a person skilled in the art will be able to make amendments to the preceding description.

1. A coding method for coding a structured document comprising a plurality of values to code, the method being characterized in that it comprises the following steps,
creating (400) a first dictionary on the basis of said values to code;
calculating (440) differences between at least two consecutive elements of said created first dictionary;
creating (460) a second dictionary on the basis of the calculated differences; and,
coding (480) said plurality of values of said document on the basis of said created first dictionary and second dictionary.

2. A method according to claim 1 wherein said created first dictionary comprises each value of said values to code, without repetition.

3. A method according to claim 1, further comprising a step of sorting (410) the elements of at least one created dictionary, prior to said step of calculating the differences.

4. A method according to claim 1 further comprising a step of indexing the elements of at least one created dictionary, prior to the step of coding said plurality of values, the coding of at least one value to code comprising a step of substituting said at least one value to code by an index.

5. A method according to claim 1 further comprising a step of calculating differences between at least two consecutive elements of said created second dictionary and a step of creating a third dictionary on the basis of said differences calculated on the basis of said created second dictionary, said plurality of values of said document being coded on the basis of said created first dictionary, second dictionary, and third dictionary.

6. A method according to claim 1 further comprising a step of normalizing (310) at least one value of said plurality of values.

7. A method according to the preceding claim in which at least some of the values of said plurality of values represent coordinates, said normalizing step comprising a step of converting absolute coordinates into relative coordinates or of converting relative coordinates into absolute coordinates.

8. A method according to claim 1 in which at least some of the values of said plurality of values represent coordinates, each component of said plurality of values forming a plurality of values being coded independently.

9. A method according to claim 1 further comprising a step of comparing at least two said differences calculated between at least three elements of a created dictionary with at least one predetermined threshold, said at least two said differences being considered as distinct if their difference is greater than said predetermined threshold.

10. A method according to claim 1 in which said plurality of values to code belongs to a path of SVG type, said method further comprising a step of separating between said plurality of values and at least one command.

11. A method of decoding of a structured document comprising a plurality of coded values, the structured document being coded according to the coding method of claim 1, the method of decoding being characterized in that it comprises the following steps,
obtaining (610, 640) a set of values representing differences between a plurality of elements of a first dictionary based on said plurality of coded values;
calculating (650) the elements of said first dictionary on the basis of said values obtained;
calculating elements of a second dictionary on the basis of said elements of said first dictionary and of said plurality of coded values; and,
decoding (670) at least one value of said plurality of coded values on the basis of said first dictionary and said second dictionary.

12. A method according to the preceding claim further comprising a step of calculating elements of a third dictionary on the basis of said elements of said second dictionary and of said plurality of coded values, said at least one decoded value being decoded on the basis of said first dictionary, said second dictionary, and said third dictionary.

13. A method according to claim 11 further comprising a step (660) of index decoding, said step of decoding at least one value of said plurality of coded values comprising a step of substituting a decoded index by a value of one of said dictionaries.

14. A computer program comprising instructions adapted for the implementation of each of the steps of the method according to claim 1 when the computer program is executed on a computer.

15. Information storage means, removable or not, partially or totally readable by a computer or a microprocessor containing code instructions of a computer program for executing each of the steps of the method according to claim 1.

16. A computer program comprising instructions adapted for the implementation of each of the steps of the method according to claim 11 when the computer program is executed on a computer.

17. Information storage means, removable or not, partially or totally readable by a computer or a microprocessor containing code instructions of a computer program for executing each of the steps of the method according to claim 11.

18. A coding device for coding a structured document comprising at least one plurality of values to code, the device being characterized in that it comprises the following means,
means for creating (400) a first dictionary on the basis of said values to code;
means for calculating (440) the differences between at least two consecutive elements of said created first dictionary;
means for creating (460) a second dictionary on the basis of the calculated differences; and,
means for coding (480) said plurality of values of said document on the basis of said created first dictionary and second dictionary.

19. A device according to claim 18, further comprising means for sorting (410) elements of at least one created dictionary, prior to said calculation of the differences.

20. A device according to claim 18 further comprising means for indexing elements of at least one created dictionary, prior to said coding of said plurality of values, said means for coding said plurality of values comprising means for substituting at least one of said values to code by an index.

21. A device according to claim 18 further comprising means for calculating differences between at least two consecutive elements of said created second dictionary and means for creating a third dictionary on the basis of said differences calculated on the basis of said created second dictionary, said plurality of values of said document being coded on the basis of said created first dictionary, second dictionary, and third dictionary.

22. A device according to claim 18 further comprising means for comparing at least two said differences calculated between at least three elements of a created dictionary with at least one predetermined threshold, said at least two said differences being considered as distinct if their difference is greater than said predetermined threshold.

23. A device for decoding of a structured document comprising a plurality of coded values, the device being characterized in that it comprises the following means,
means for obtaining (610, 640) a set of values representing differences between a plurality of elements of a first dictionary based on said plurality of coded values;
means for calculating (650) elements of said first dictionary on the basis of said values obtained;
means for calculating elements of a second dictionary on the basis of said elements of said first dictionary and of said plurality of coded values; and,
means for decoding (670) at least one value of said plurality of coded values on the basis of said first dictionary and second dictionary.

24. A device according to the preceding claim, further comprising means for decoding indices (660), said means for decoding at least one value of said plurality of coded values comprising means for substituting a decoded index by a value of one of said dictionaries.
